(19) United States
(12) Patent Application Publication
(10) Pub. No.: US 2020/0137831 A1
(43) Pub. Date: Apr. 30, 2020

(54) FREQUENCY BAND AUTHENTICATION METHOD AND APPARATUS FOR WIRELESS DEVICE, AND COMPUTING DEVICE

(71) Applicant: SZ DJI TECHNOLOGY CO., LTD., Shenzhen (CN)

(72) Inventor: Ning MA, Shenzhen (CN)

(21) Appl. No.: 16/730,115

(22) Filed: Dec. 30, 2019

Related U.S. Application Data
(63) Continuation of application No. PCT/CN2017/098819, filed on Aug. 24, 2017.

(51) Int. Cl. H04W 84/20; B64C 39/02; G05D 1/00; H04W 52/02; H04B 17/318; H04W 72/04; H04W 12/06

(52) U.S. Cl. CPC H04W 84/20; B64C 39/024; G05D 1/0038; H04W 12/06; H04B 17/318; H04W 72/0453; H04W 52/0212

(57) ABSTRACT

A wireless-device frequency-band authentication method for a master device communicating with a slave device includes when using a first frequency band to transmit a signal to the slave device, using, by the master device, a receiving channel to perform an evaluation on a second frequency band to be authenticated; determining, by the master device, whether the evaluation conforms to a preset standard; and when it is determined that the evaluation conforms to the preset standard, notifying, by the master device, the slave device of using the second frequency band to communicate with the master device.

### CROSS-REFERENCE TO RELATED APPLICATION

This application is a continuation of International Application No. PCT/CN2017/098819, filed on Aug. 24, 2017, the entire content of which is incorporated herein by reference.

### TECHNICAL FIELD

The present disclosure relates to wireless control technologies and, more particularly, to frequency-band authentication method and apparatus for a wireless device, and computing device thereof.

### BACKGROUND

With the development of wireless control technology, wireless devices such as unmanned aerial vehicles (UAVs) are widely used in the manufacturing field and daily life. After the pairing of a control terminal and a device terminal of a wireless device is completed, the information exchange is achieved by communicating on a pre-agreed frequency band to carry out operations for controlling and being-controlled. Here, the frequency band resources used by the wireless device need to comply with regulations of the relevant laws. In addition to vendors or industry organizations reporting in advance, some specific frequency band resources need to be authenticated in real time to prevent interference with priority signals in the same frequency band.

Taking 5.47 GHz-5.725 GHz frequency band for UAV communication as an example, a device must perform dynamic frequency selection (DFS) authentication during the use of the frequency band to prevent interference with radar signals that possibly exist. Generally, the requirements of the DFS authentication are relatively high. Taking the federal communications commission (FCC) as an example, if the use of signal channels in 5.47 GHz-5.725 GHz frequency band is desired, continuously monitoring the relevant channels for 60 seconds is needed. If no radar signal is detected, the signal channels are allowed to be used. Meanwhile, it is still required to continuously monitor radar signals when the signal channels are operating.

Because most of the available tests for frequency-band authentications are accompanied by certain time duration requirements (such as the 60-second requirement for the above-described DFS authentication), if the wireless device is forced to monitor only the radar signals without performing normal communication during this time duration, availability of the device may be reduced significantly, or even cannot be achieved in some specific scenarios, such as UAVs. For such requirement, currently, additional sniffer channels are added in factory to the UAVs or remote controller to monitor the relevant signals. However, such method may increase the communication cost, and the additional hardware requirements are unfavorable factors for the load and endurance of the UAVs.

It is to be understood that the above general descriptions are merely illustrative explanations of the related art and does not represent the prior art of the present disclosure.

### SUMMARY

In accordance with the disclosure, there is provided a wireless-device frequency-band authentication method for a master device communicating with a slave device. The method includes when using a first frequency band to transmit a signal to the slave device, using, by the master device, a receiving channel to perform an evaluation on a second frequency band to be authenticated; determining, by the master device, whether the evaluation conforms to a preset standard; and when it is determined that the evaluation conforms to the preset standard, notifying, by the master device, the slave device of using the second frequency band to communicate with the master device.

Also in accordance with the disclosure, there is provided an unmanned aerial vehicle communicating with a slave device. The unmanned aerial vehicle includes a detecting circuit configured to use a receiving channel to perform an evaluation on a second frequency band to be authenticated, when using a first frequency band to transmit a signal to the slave device, and to determine whether the evaluation conforms to a preset standard; and a notifying circuit configured to notify the slave device of using the second frequency band to communicate with unmanned aerial vehicle, when it is determined that the evaluation conforms to the preset standard.

### BRIEF DESCRIPTION OF THE DRAWINGS

FIG. 1 is a flowchart of a frequency-band authentication method for a wireless device according to an embodiment of the present disclosure;

FIG. 2 is a schematic diagram of an evaluation process of a second frequency band in the embodiment shown in FIG. 1;

FIG. 3 is a flowchart of a frequency-band authentication method for a wireless device according to another embodiment of the present disclosure;

FIG. 4 is a flowchart of another frequency-band authentication method for a wireless device according to another embodiment of the present disclosure;

FIG. 5 illustrates a structural diagram of a frequency-band authentication apparatus for a wireless device according to an embodiment of the present disclosure;

FIG. 6 illustrates a structural diagram of another band authentication apparatus for a wireless device according to another embodiment of the present disclosure; and

FIG. 7 illustrates a schematic diagram of a band authentication device for a wireless device according to another embodiment of the present disclosure.

### DETAILED DESCRIPTION OF THE EMBODIMENTS

Technical solutions of the present disclosure will be described with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

Exemplary embodiments will be described with reference to the accompanying drawings, in which the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

The principles and spirit of the present disclosure will be described below with reference to some exemplary embodiments. It should be understood that, embodiments are provided merely for those skilled in the art to better understand and implement the present disclosure, and do not limit the scope of the present disclosure in any way. On the contrary, those embodiments are provided to make the present disclosure more thorough and complete, so that the scope of the present disclosure can be conveyed to those skilled in the art.

It is understood to those skilled in the art that, the embodiments of the disclosure can be implemented as a system, apparatus, device, method or computer program product. Thus, the present disclosure can be implemented in the form of hardware, software (including firmware, resident software, microcode, etc.), or combinations of hardware and software.

According to the embodiments of the present disclosure, a frequency-band authentication method and apparatus for a wireless device and a computing device are provided.

The principles and spirit of the present disclosure are explained in detail below with reference to some exemplary embodiments of the present disclosures.

Without losing generality, in the following embodiments of the present disclosure, a master device and a slave device are used to describe the frequency-band authentication operation in the communication process between the master device and the slave device, unless otherwise specified. There is no restriction that the master device and the slave device are respectively a controlling device and a controlled device.

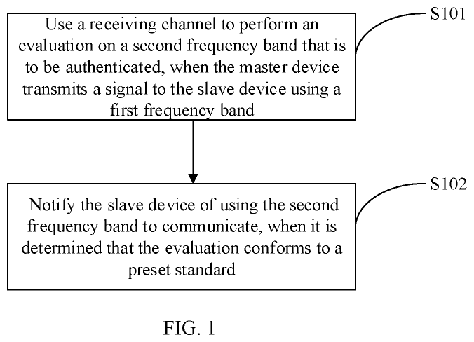

FIG. 1 is a flowchart of a frequency-band authentication method of a wireless device according to an embodiment of the present disclosure. The method can be applied to a master device that communicates with a slave device. With reference to FIG. 1, the method includes the following processes S101 and S102.

In S101, when the master device transmits a signal to the slave device using a first frequency band, a receiving channel is used to perform an evaluation on a second frequency band that is to be authenticated.

In S102, when it is determined that the evaluation conforms to a preset standard, the master device notifies the slave device of using the second frequency band to communicate.

According to the above-described embodiments of the present disclosure, the master device may use a receiving channel to perform the evaluation of the second frequency-band authentication. Adding a new monitoring circuit is not needed and, thus, the existing resources can be used to achieve authentication operations of the second frequency band without affecting normal communications. Communication cost can be reduced, and the load caused by additional hardware can be prevented.

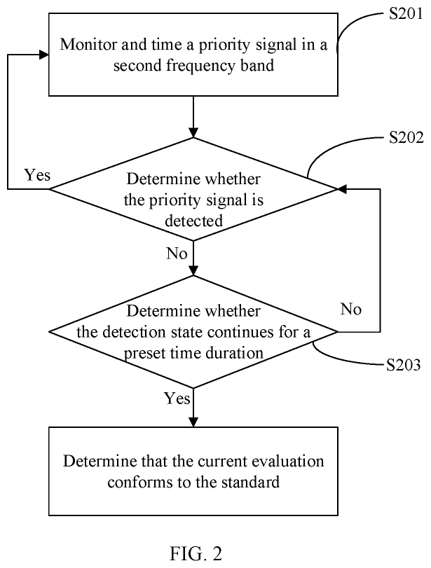

In some embodiments, an example of the evaluation process of S101 is illustrated in FIG. 2, and can include the following processes S201-S203.

In S201, a priority signal is monitored and timed in a second frequency band.

In some embodiments, the priority signal may be a radar signal.

In S202, it is determined whether the priority signal is detected. If the priority signal is detected, timing is restarted and the process proceeds to S201, and if the priority signal is not detected, the process proceeds to S203.

In S203, it is determined whether the state of no detection of priority signals continues for a preset time duration. If the state of no detection of priority signals continues for the preset time duration, it is determined that the current evaluation conforms to the standard. If the state of no detection of priority signals does not continue for the preset time duration, the method proceeds to S202 to continue to determine whether any priority signal is detected.

In some embodiments, the preset time duration is approximately 60 seconds.

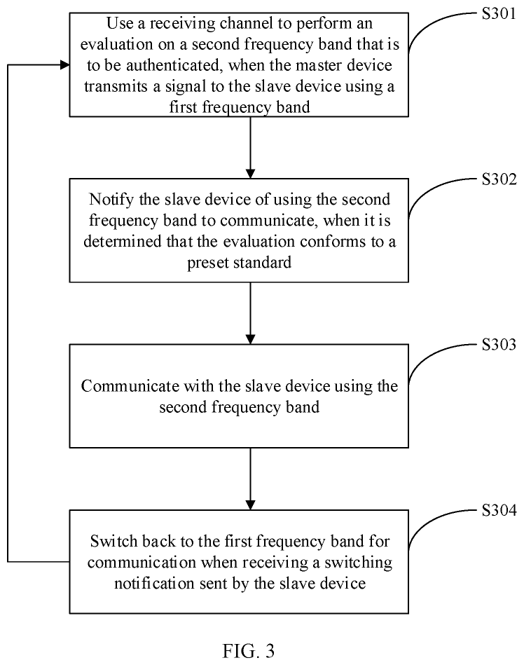

FIG. 3 is a flowchart of a frequency-band authentication method for a wireless device according to another embodiment of the present disclosure. The method can be applicable to a master device that communicates with a slave device. With reference to FIG. 3, the method includes the following processes S301-S304.

In S301, when the master device transmits a signal to the slave device using a first frequency band, a receiving channel is used to perform an evaluation on a second frequency band that is to be authenticated.

In S302, when it is determined that the evaluation conforms to a preset standard, the master device notifies the slave device of using the second frequency band to communicate.

S301-S302 respectively correspond to S101-S102 in the embodiments described in connection with FIG. 1, and details are not repeated here.

In S303, the master device communicates with the slave device using the second frequency band.

In S304, the master device switches back to the first frequency band for communication when receiving a switching notification sent by the slave device, and the switching notification is generated by the slave device according to an evaluation of the priority signal in the second frequency band.

In some embodiments, the priority signal may be a radar signal, and the signal communicated between the master and slave devices may be an image signal.

In some embodiments, in S303, the master device in S303 may adjust, according to a preset power threshold, the power of the transmitted signal when communicating with the slave device using the second frequency band, so as to ensure that the detection of the priority signal is not affected when the slave device receives the transmitted signal. For example, the master device may determine the transmitting power of the current signal by detecting the received signal strength indication (RSSI) in real time, and set a threshold to ensure that the transmitted signal does not interfere with the priority signal (e.g., the radar signal).

In some embodiments, the master device may refer to a UAV, and the slave device may refer to a remote controller, thereby utilizing the asymmetry of the uplink and downlink channels in the UAV communication system. That is, most of the time, the UAV transmits signals and the remote controller receives signals. However, the embodiments of the present disclosure are not limited thereto.

In some embodiments, the second frequency band may be in a range from approximately 5.47 GHz to approximately 5.725 GHz. There is less interference in such frequency band, where relatively high transmitting power may be allowed, and which is a desired frequency band for UAV communications. Further, in most countries, performing frequency band DFS authentication in this frequency band is needed to avoid interference with radar signals that possibly exist. Accordingly, the embodiments of the present disclosure provide a frequency-band authentication method, which can achieve the frequency-band authentication without adding extra monitoring channels.

According to the above-described embodiments of the present disclosure, the evaluation of the second frequency-band authentication may be alternately performed by the master and slave devices, and there is no need to add a new monitoring circuit, and no hardware modification is needed for the master device and/or slave device. Thus, the existing resources can be utilized to implement the second frequency-band authentication operation without adding or occupying additional receiving channels. Communication cost can be saved, and the load caused by additional hardware can be prevented.

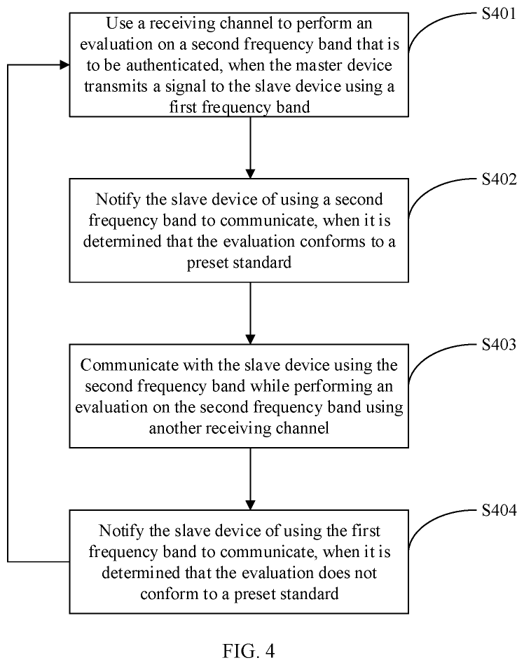

FIG. 4 is a flowchart of another frequency-band authentication method for a wireless device according to another embodiment of the present disclosure. The method can be applied to a master device that communicates with a slave device. The master device may include a plurality of receiving channels. With reference to FIG. 4, the method includes the following processes S401-S404.

In S401, when the master device transmits a signal to the slave device using a first frequency band, a receiving channel is used to perform an evaluation on a second frequency band that is to be authenticated.

In S402, when it is determined that the evaluation conforms to a preset standard, the master device notifies the slave device of using the second frequency band to communicate.

S401-S402 respectively correspond to S101-S102 in the embodiments of FIG. 1, and details are not repeated here.

In S403, the master device communicates with the slave device using the second frequency band while performing an evaluation on the second frequency band using another receiving channel.

In some embodiments, because the master device may include a plurality of receiving channels, the master device may receive signals sent from the slave device using the second frequency band through one of the receiving channels, and meanwhile continue performing the evaluation on second frequency band through another receiving channel. If it is determined that the evaluation conforms to a preset standard, the master device continue using the second frequency band to communicate with the slave device. Otherwise, the process proceeds to S404.

In S404, when it is determined that the evaluation does not conform to a preset standard, the master device notifies the slave device of using the first frequency band to communicate.

When it is determined that the evaluation in S403 does not conform to the preset standard, it indicates that the master and slave devices are not suitable for using the second frequency band to communicate. Thus, the master device notifies the slave device of switching back to the first frequency band for communication, and the process proceeds to S401 to continue to perform the evaluation on the second frequency band.

According to the above-described embodiments of the present disclosure, the evaluation for the second frequency-band authentication may be performed by the master device that includes a plurality of receiving devices. There is no need to add a new monitoring circuit, and no hardware modification is needed for the master and slave devices. The existing resources can be utilized to implement the second frequency-band authentication operation without affecting normal communications of the master device and the slave device. Communication cost can be reduced, and the load caused by additional hardware can be prevented.

It should be noted that, although the various processes of the methods of the present disclosure are described in particular orders in the accompanying drawings, it does not require or imply that the processes need be performed in the specific orders or that all the processes shown need to be performed in order to achieve the desired results. Additionally or alternatively, certain processes may be omitted, multiple processes may be combined into one process for execution, and/or one process may be divided into multiple processes for execution, etc. Further, it is also readily understood that these processes can be, for example, performed synchronously or asynchronously in multiple circuits/processes/threads.

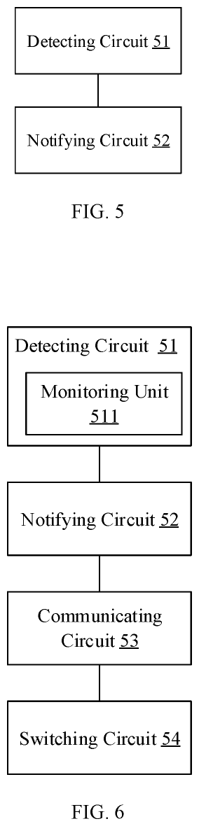

FIG. 5 illustrates a structural diagram of a frequency-band authentication apparatus for a wireless device according to an embodiment of the present disclosure. The frequency-band authentication apparatus of the example embodiment can be applied to a master device that communicates with a slave device. With reference to FIG. 5, the frequency-band authentication apparatus includes a detecting circuit 51 and a notifying circuit 52.

The detecting circuit 51 is configured to perform an evaluation, using a receiving channel, on a second frequency band that is to be authenticated, when the master device transmits a signal to the slave device using a first frequency band. The notifying circuit 52 is configured to notify the slave device of using the second frequency band to communicate when it is determined that the evaluation by the detecting circuit 51 conforms to a preset standard.

According to the above-described embodiments of the present disclosure, the evaluation for the second frequency-band authentication may be performed by the master device, and authentication operations of the second frequency band can be achieved without affecting the normal communication.

Based on the apparatus shown in FIG. 5, in some embodiments, the detecting circuit 51 may be further configured to perform an evaluation on the second frequency band using another receiving channel when the master device communicates with the slave device using the second frequency band. Further, when the detecting circuit 51 determines that the evaluation does not conforms to a preset standard, the detecting circuit 52 causes the notifying circuit 52 to notify the slave device of switching back to the first frequency band for communication. In some embodiments, the master device may include a plurality of receiving channels. Thus, the master device may use the second frequency band to receive signals sent by the slave device through one of the receiving channels, and meanwhile continue performing an evaluation on the second frequency band through another receiving channel. If it is determined that the evaluation conforms to a preset standard, the master device continues using the second frequency band to communicate with the slave device. Otherwise, the notifying circuit 52 notifies the slave device of switching back to the first frequency band for communication.

FIG. 6 illustrates a structural diagram of another band authentication apparatus for a wireless device according to another embodiment of the present disclosure. In addition to circuits in FIG. 5, the frequency-band authentication apparatus may further include a communicating circuit 53 and a switching circuit 54. The detecting circuit 51 further includes a monitoring unit 511.

The communicating circuit 53 is configured to use a second frequency band to communicate with the slave device. The switching circuit 54 is configured to cause the communicating circuit 53 to switch back to the first frequency band for communication when receiving a switching notification sent by the slave device, where the switching notification is generated by the slave device according to an evaluation on a priority signal of the second frequency band. The monitoring unit 511 is configured to monitor and time the priority signal in the second frequency band, and determine that the evaluation conforms to a preset standard when the priority signal is not detected for a preset time duration (e.g., approximately 60 seconds). The monitoring unit 511 is further configured to, when the priority signal is detected, restart timing and continue to monitor the priority signal.

In some embodiments, the communicating circuit 53 may adjust, according to a preset power threshold, the power of the transmitted signal of the communicating circuit 53 when the communicating circuit 53 communicates with the slave device using the second frequency band, so as to ensure that the detection of the priority signal is not affected when the slave device receives the transmitted signal. For example, the communicating circuit 53 may determine the transmitting power of the current signal by detecting the RSSI in real time, and may set a threshold to ensure that the transmitted signal does not interfere with the priority signal.

According to the above-described embodiments of the present disclosure, the master device and the slave device may perform alternately the evaluation of the second frequency-band authentication, and authentication operations of the second frequency band can be realized without increasing or occupying an extra receiving channel.

In some embodiments, the above-described priority signal may be a radar signal, and the signal communicated between the master device and the slave device is an image signal.

In some embodiments, the master may be a UAV, and the slave device may be a remote controller, thereby utilizing the asymmetry of the uplink and downlink channels in the UAV communication system. That is, most of the time, the UAV transmits signals and the remote controller receives signals. However, the embodiments of the present disclosure are not limited thereto.

In some embodiments, the second frequency band may be in a range from approximately 5.47 GHz to approximately 5.725 GHz. There is less interference in such frequency band, where relatively high transmitting power may be allowed, and which is a desired frequency band for UAV communications. Further, in most countries, performing a frequency band DFS authentication in this frequency band is needed to avoid interference with radar signals that possibly exist. Accordingly, the embodiments of the present disclosure provide a frequency-band authentication method, which can achieve the frequency-band authentication without adding extra monitoring channels.

With regard to the apparatuses in the above-described embodiments, the detailed methods in which each circuit performs the operations are described in detail in the method embodiments, and are not repeated here.

It should be noted that although several circuits or units of devices for action execution are provided in the detailed descriptions above, such division is not mandatory. Indeed, in accordance with embodiments of the present disclosure, the features and functions of two or more circuits or units described above may be implemented in one circuit or unit. Further, the features and functions of one circuit or unit described above may be implemented in a plurality of circuits or units. The circuits or units described as separate components may or may not be physically separate, and a component shown as a circuit or unit may or may not be a physical unit. That is, the circuits or the units may be located in one place or may be distributed over a plurality of network elements. Some or all of the components may be selected according to the actual needs to achieve the object of the present disclosure. Those of ordinary skill in the art can understand and implement without any creative effort.

In exemplary embodiments, there is also provided a computer readable storage medium having computer programs stored thereon. The computer programs are executable by a processor to implement the processes of the frequency-band authentication method for a wireless device of any one of the above-described embodiments. For the specific processes of the frequency-band authentication method for a wireless device, references may be made to the detailed description of the processes in the foregoing method embodiments, and details are not repeated here. The computer readable storage medium may be a read-only memory (ROM), a random access memory (RAM), a compact disc read-only memory (CD-ROM), a magnetic tape, a floppy disk, an optical data storage device, etc.

In exemplary embodiments, there is also provided a computing device that can be applied to a master device that communicates with a slave device. Further, the computing device may include a hardware processor and a memory for storing executable instructions of the hardware processor. The hardware processor is configured to cause, by executing the executable instructions, a server to perform the processes of the frequency-band authentication method for a wireless device described in any one of the above embodiments. For the processes of the frequency-band authentication method for a wireless device, references can be made to the detailed descriptions in the foregoing method embodiments, and details are not repeated here.

Through the descriptions of the above embodiments, those skilled in the art can understand that the example embodiments described herein may be implemented by software, or may be implemented by software in combination with necessary hardware. Therefore, the technical solution according to the embodiments of the present disclosure may be in the form of a software product, which may be stored in a non-volatile storage medium (which may be a CD-ROM, a universal serial bus flash drive, a mobile hard disk, etc.) or on a network, and may include a number of instructions to cause a computing device (which may be a personal computer, server, touch terminal, or network device, etc.) to perform the above-described methods in accordance with embodiments of the present disclosure.

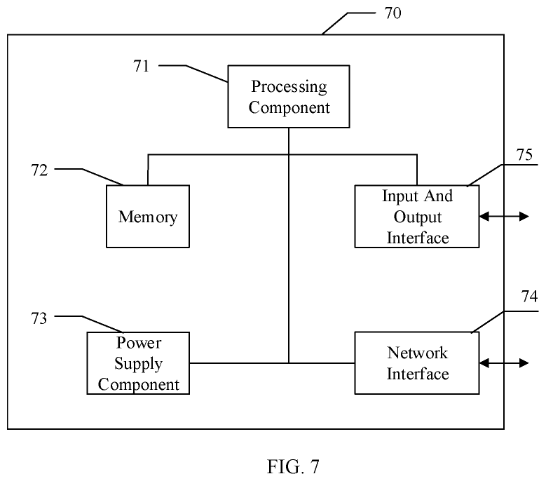

FIG. 7 illustrates a schematic diagram of a frequency-band authentication device 70 according to another embodiment of the present disclosure. The device 70 may be any appropriate wireless communication device, such as a UAV. Referring to FIG. 7, the device 70 includes a processing component 71 that further includes one or more hardware processors, and memory resources represented by memory 72 for storing instructions executable by the processing component 71, such as application programs. An application program stored in memory 72 may include one or more modules each corresponding to a set of instructions. Further, the processing component 71 is configured to execute instructions to perform the frequency-band authentication method for a wireless device described above.

The device 70 may further include a power supply component 73 configured to perform power management of the device 70, a wired or wireless network interface 74 configured to connect the device 70 to a network, and an input and output (I/O) interface 75. The device 70 can operate based on an operating system stored in memory 72, such as Windows Server, Mac OS X, Unix, Linux, FreeBSD or the like.

Those of ordinary skill in the art will appreciate that the example elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

For simplification purposes, detailed descriptions of the operations of exemplary systems, devices, and units may be omitted and references can be made to the descriptions of the various methods.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the example methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A wireless-device frequency-band authentication method for a master device communicating with a slave device, the method comprising:
when using a first frequency band to transmit a signal to the slave device, using, by the master device, a receiving channel to perform an evaluation on a second frequency band to be authenticated;
determining, by the master device, whether the evaluation conforms to a preset standard; and
when it is determined that the evaluation conforms to the preset standard, notifying, by the master device, the slave device of using the second frequency band to communicate with the master device.

2. The method according to claim 1, after notifying the slave device of using the second frequency band to communicate with the master device, further comprising:
using, by the master device, the second frequency band to communicate with the slave device; and
switching back to the first frequency band for communication when receiving a switching notification sent by the slave device, wherein the switching notification is generated by the slave device according to an evaluation performed by the slave device on a priority signal in the second frequency band.

3. The method according to claim 2, wherein:
the master device adjusts, according to a preset power threshold, a power of a transmitted signal when the second frequency band is used to communicate with the slave device.

4. The method according to claim 1, wherein using the receiving channel to perform the evaluation includes:
monitoring and timing a priority signal in the second frequency band;
determining that the evaluation conforms to the preset standard in response to the priority signal not being detected during a preset time duration; and
restarting timing and continuing to monitor the priority signal in response to the priority signal being detected.

5. The method according to claim 1 wherein:
the master device is an unmanned aerial vehicle; and
the slave device is a remote controller.

6. The method according to claim 1, wherein:
the second frequency band is in a range from approximately 5.47 GHz to approximately 5.725 GHz.

7. The method according to claim 1, wherein:
the transmitted signal is an image signal.

8. The method according to claim 2, wherein:
the priority signal is a radar signal.

9. An unmanned aerial vehicle communicating with a slave device, comprising:
a detecting circuit configured to use a receiving channel to perform an evaluation on a second frequency band to be authenticated, when using a first frequency band to transmit a signal to the slave device, and to determine whether the evaluation conforms to a preset standard; and
a notifying circuit configured to notify the slave device of using the second frequency band to communicate with unmanned aerial vehicle, when it is determined that the evaluation conforms to the preset standard.

10. The unmanned aerial vehicle according to claim 9, further comprising:
a communicating circuit configured to use the second frequency band to communicate with the slave device; and
a switching circuit configured to cause the communicating circuit to switch back to the first frequency band for communication when receiving a switching notification sent by the slave device, wherein the switching notification is generated by the slave device according to an evaluation performed by the slave device on a priority signal in the second frequency band.

11. The unmanned aerial vehicle according to claim 10, wherein:
the communicating circuit adjusts, according to a preset power threshold, a power of a transmitted signal when the second frequency band is used to communicate with the slave device.

12. The unmanned aerial vehicle according to claim 9, wherein the detecting circuit includes a monitoring unit configured to:
monitor and time a priority signal in the second frequency band,
determine that the evaluation conforms to the preset standard in response to the priority signal not being detected during a preset time duration, and
restart timing and continue to monitor the priority signal in response to the priority signal being detected.

13. The unmanned aerial vehicle according to claim 9, wherein:
the slave device is a remote controller.

14. The unmanned aerial vehicle according to claim 9, wherein:
the second frequency band is in a range from approximately 5.47 GHz to approximately 5.725 GHz.

15. The unmanned aerial vehicle according to claim 9, wherein:
the transmitted signal is an image signal.

16. The unmanned aerial vehicle according to claim 10, wherein:
the priority signal is a radar signal.
